(19) United States
(12) Patent Application Publication
(10) Pub. No.: US 2013/0053421 A1
(43) Pub. Date: Feb. 28, 2013

(54) Method for Flying Insect Control

(71) Applicants: James F. Walter, Furlong, PA (US); Allan Dufoe, Annapolis, MD (US); Dina L. Richman, Philadelphia, PA (US)

(72) Inventors: James F. Walter, Furlong, PA (US); Allan Dufoe, Annapolis, MD (US); Dina L. Richman, Philadelphia, PA (US)

(73) Assignee: FMC CORPORATION, Philadelphia, PA (US)

(21) Appl. No.: 13/517,413

(22) PCT Filed: Jan. 5, 2011
(86) PCT No.: PCT/US11/20169

§ 371 Date: Jun. 20, 2012

Related U.S. Application Data
(60) Provisional application No. 61/292,634, filed on Jan. 6, 2010.

(51) Int. Cl. A01N 43/40; A01P 7/04

(52) U.S. Cl. 514/357

(57) ABSTRACT

The present invention relates to a flying insect trap insecticidal insert which is coated on at least one side with a composition comprising a neonicotinoid insecticide and a food attractant.

### FIELD OF THE INVENTION

The present invention relates to flying insect trapping devices which contain an insecticidal appliance and to a method of controlling flying insects.

### BACKGROUND OF THE INVENTION

The problem of ridding an indoor area of flies and other flying insects has existed for many years. Flies are not only annoying, but also harmful to humans because they breed filth and carry various and numerous pathogenic germs and spread disease. As a result, it is desirable to kill and remove flies not only in one's home, but also in such commercial and public areas as food markets, restaurants, areas around and near trash recepticles and the like.

Flying insect trapping devices which use light sources and replaceable adhesive sheets or glue boards, work very well for their intended purpose. Representatives of these devices are disclosed in U.S. Pat. Nos. 4,696,126, 4,949,501, 4,117,624, 5,915,948, 6,108,966 and 7,469,499. Flying insect traps are available commercially that attract and trap insects, such as flies, using UV light and pheromones added to the glue board, for example, CB® I.Q. Pro Flylight and CB® I.Q. Standard Flylight, both available from CB Professional Products. Although the devices described above are designed for easy replacement of the adhesive sheets or glue boards, frequent replacement is necessary if an unpleasant appearance or smell due to decaying insects is to be avoided, and the process may still be a very unpleasant procedure. When light traps with glue boards are used to control heavy fly infestations, a common complaint from pest management professionals is that the glue boards fill up with dead flies so quickly that the efficacy of the trap is reduced in a short period time. In order to maintain efficacy, the glue board has to be replaced frequently.

It would be advantageous to provide an easy to use, inexpensive flying insect trap appliance, which is effective when compared with conventional trap adhesive sheets or glue boards without having to replace bug encrusted adhesive sheets or glue boards.

### SUMMARY OF THE INVENTION

In accordance with the present invention, it has now been found that a flying insect trap appliance which comprises an insecticide and an attractant composition applied to the appliance, controls flying insects without fouling the appliance. In particular, the present invention relates to a flying insect trap appliance which is coated with a composition comprising a neonicotinoid insecticide and a food attractant. Other aspects of the present invention will also be apparent.

### DETAILED DESCRIPTION OF THE INVENTION

The present invention relates to a flying insect trap insecticidal appliance, which is used in place of a glue board, and comprises an insecticide and an attractant composition applied to at least one side of the appliance. In particular, the present invention relates to a flying insect trap insecticidal appliance which is coated on at least one side with a composition comprising a neonicotinoid insecticide and a food attractant.

The appliance support should be made of a material that will retain the insecticide/attractant mixture throughout the useful life of the insecticide/attractant mixture. Suitable support materials that may be used include, for example: flexible films such as transparency films, for example 3M brand transparency films PP2200, PP2500 and PP2950; plastics such as high density polyurethane, PVC and PVA; and other supportive materials such as cardboard, plexiglass, glass, ceramic, metal, and wood.

When using the insecticidal appliance in place of a glue board in a flying insect trap, insects that have been drawn into the trap are further attracted to the insecticide/attractant coating on the appliance and, upon contact, or ingestion of the insecticide/attractant coating, die and fall to the bottom of the trap to be collected in a removable collection container, for example, a tray or drawer. Some insect trapping devices expose two sides of a glue sheet to trap flies, for example, the device described in U.S. Pat. No. 6,108,966. When using the insecticidal appliance of the present invention in place of a double sided glue sheet, one would coat both sides of the appliance with a mixture comprising an insecticide and attractant.

An advantage to using the insecticide/attractant coated appliance of the present invention is that the composition comprising a neonicotinoid insecticide and a food attractant can last for up to 6 months or more. Another advantage is that if one side of the appliance is coated with an insecticide/attractant coating, the opposite side can have an adhesive applied to it so that the appliance can be attached inside or outside any flying insect trap or be used alone by attaching the appliance to a wall or ceiling.

The insecticide/attractant mixture preferably comprises a neonicotinoid insecticide and a food attractant. The neonicotinoid insecticide can be one or more insecticide selected from (E)-N-[(6-chloro-3-pyridinyl)methyl]-N′-cyano-N-methylethanimidamide (acetamiprid) and 1-[(6-chloro-3-pyridinyl)methyl]-N-nitro-2-imidazolidinimine (imidacloprid). The preferred insecticide is acetamiprid. The neonicotinoid insecticide is preferably present in the insecticide/attractant mixture in a range of from 0.1% to 10% by weight, more preferably in a range of from 0.3% to 5% by weight of all the components in the insecticide/attractant mixture. The food attractant is preferably one or more food attractant selected from granulated sugar, raw sugar or liquid sugar syrup, for example, high fructose corn syrup or maple syrup. The food attractant is preferably present in a range of from 90% to 99.8% by weight, preferably in a range of 95% to 96% by weight of all the components in the insecticide/attractant mixture. The insecticide/attractant mixture can further comprise a bittering agent, for example, BITREX® brand of denatonium benzoate available from MacFarlan Smith, and can be present in a range of from 0.01% to 0.1% by weight of all of the components in the mixture.

The following examples further illustrate the present invention, but, of course, should not be construed as in any way limiting its scope. The examples set forth certain data demonstrating the improved efficacy of the compositions of the present invention.

### EXAMPLE 1

### Preparation and Testing of an Insecticide/Attractant Coated Fly Trap Insert

Into a blender was added 955.5 grams of high fructose corn syrup, 44.0 grams of technical acetamiprid and 0.5 gram of denatonium benzoate. The mixture was blended for 30 minutes, forming a thick syrup. Clear plastic film inserts, measuring 1 inch by 6 inches each, having an adhesive coating protected by a paper sheet on one side, were roller coated with the insecticide/attractant syrup on the side opposite from the adhesive, and allowed to dry. Once dry, the insecticide/attractant coating was protected from damage with a paper covering.

The insecticide/attractant coated inserts of the present invention were tested for insecticidal activity in the following manner:

On the first day of each experiment, 60 house fly (Musca domestica) pupae were placed in a plastic weigh boat on the floor of a simulated kitchen. The simulated kitchen measured 3.1 meters×1.9 meters×2.7 meters and was a replica of real household kitchen having painted wood panel walls, vinyl tile floor and standard floor and wall cabinets. The simulated kitchen had one window allowing ambient light to enter and two overhead florescent lights. The simulated kitchen was fly escape proof with the only entrance located in the ceiling. A commercial fly light trap, CB® I.Q. Standard Flylight, was affixed to a wall cabinet opposite the window, approximately 3 meters from the window. The light trap lamps were on continuously for the duration of each test. A dish of water and a dish of food (a 50:50, v/v mixture of granulated sugar and powdered dry milk) were placed approximately 8 inches from the fly light trap or treatment. Tests in which the insecticide/attractant coated insert replaced the glue board, freshly opened inserts were used or inserts that were aged by exposure to the UV lights for one week were used. Adult fly emergence and mortality was assessed daily for three days or until all flies emerged. The environmental conditions were: 25° C. to 30° C., relative humidity was 23% to 53%, continuous florescent light. Each treatment was replicated four times. The treatments were:

(1) Light trap with pheromone treated glue board (CB Intellilight Universal glue board from CB Professional products).

(2) Light trap with one freshly opened insecticide/attractant insert.

(3) Light trap with one aged insecticide/attractant insert.

(4) No light trap, insecticide/attractant insert affixed directly to cabinet.

(5) Light trap no glue board or insecticide/attractant insert.

(6) No light trap, no glue board or insecticide/attractant insert.

Table 1 below summarizes the % fly mortality at 24, 48 and 72 hours for each of the treatments.

TABLE 1
Percent Fly Mortality

| | % Fly Mortality | | |
|---|---|---|---|
| | (average of 4 replicates) | | |
| Treatment | 24 hours | 48 hours | 72 hours |
| 1 | 100 | 100 | 100 |
| 2 | 73 | 100 | 100 |
| 3 | 67 | 93 | 100 |
| 4 | 48 | 74 | 80 |
| 5 | 27 | 32 | 37 |
| 6 | 15 | 21 | 22 |

As can be seen from the data in Table 1, the insecticide/attractant inserts provided fly control equivalent to glue boards when used in a fly light trap. The dead flies were easily removed from the trap since they were contained in a removable tray. The dead insects were not as visible as they were on glue board traps. The insecticide/attractant insert does not need to be replaced as often as a glue board since it does not ‘fill-up” with dead insects thereby saving the user money and time.

Those of ordinary skill in the art will appreciate that variations of the invention may be used and that it is intended that the invention may be practiced otherwise than as specifically described herein. Accordingly, this invention includes all modifications encompassed within the spirit and scope of the invention as defined by the following claims.

What is claimed is:

1. A flying insect trap insecticidal insert comprising an insecticide and an attractant composition applied to at least one side of the insert.

2. The flying insect trap insecticidal insert of claim 1 in which the insecticide is a neonicotinoid insecticide.

3. The flying insect trap insecticidal insert of claim 2 in which the neonicotinoid insecticide is one or more insecticide selected from acetamiprid or imidacloprid.

4. The flying insect trap insecticidal insert of claim 3 in which the insecticide is acetamiprid.

5. The flying insect trap insecticidal insert of claim 2 wherein the insecticide is present in a range of from 1% to 10% by weight of all the components in the insecticide and attractant composition.

6. The flying insect trap insecticidal insert of claim 1 in which the attractant is a food attractant.

7. The flying insect trap insecticidal insert of claim 6 in which the food attractant is one or more food attractant selected from granulated sugar, raw sugar or liquid sugar syrup.

8. The flying insect trap insecticidal insert of claim 6 in which the food attractant is present in a range of from 90% to 99.8% by weight of all the components in the insecticide and attractant composition.

9. The flying insect trap insecticidal insert of claim 1 further comprising a bittering agent.

10. A method of controlling flying insects wherein a flying insect trap insecticidal insert comprising an insecticide and an attractant composition applied to at least one side of the insert is placed in a location where flying insect control is desired.

11. The method of claim 8 wherein the insert is placed inside a flying insect trap.
